(19) United States
(12) Patent Application Publication
(10) Pub. No.: US 2007/0005687 A1
(43) Pub. Date: Jan. 4, 2007

(54) Voice recording and playback apparatus and voice recording and playback method

(75) Inventor: Shuichi Sato, Sagamihara-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/472,528

(22) Filed: Jun. 22, 2006

(30) Foreign Application Priority Data
Jun. 30, 2005 (JP) 2005-191210

(51) Int. Cl. G06F 15/16; G06F 15/167

(52) U.S. Cl. 709/203; 709/216

(57) ABSTRACT

A voice recording and playback apparatus, includes a first storage device which stores voice data recorded from an information terminal, a second storage device which receives a request of playing back the voice data stored in the first storage device from the information terminal and, if the information terminal has a Web function, prepares and stores a Web page from which the voice data is downloaded to the information terminal, a transmitting device which transmits URL information to access the Web page stored in the second storage device to the information terminal, and a playback apparatus which plays back the voice data stored in the first storage device, if the information terminal does not have the Web function.

### CROSS-REFERENCE TO RELATED APPLICATIONS

This application is based upon and claims the benefit of priority from Japanese Patent Application No. 2005-191210, filed Jun. 30, 2005, the entire contents of which are incorporated herein by reference.

### BACKGROUND

1. Field

One embodiment of the invention relates to this invention relates to a voice recording and playback apparatus and a voice recording and playback method, in which a telephone terminal or the like having a Web function downloads voice mails and the like as voice data and plays them back by itself, if the voice mails are recorded and played back from the telephone terminal.

2. Description of the Related Art

In recent years, a voice network including a key telephone unit and a voice recording and playback apparatus connected by IP (Internet Protocol) network has begun to be constructed. The voice recording and playback apparatus is connected to a key telephone unit, another voice recording and playback apparatus, and IP telephone terminals through the IP network. Voice recording and playback apparatuses record a number of voices by compressing voice of 64 Kbps, and require an expensive voice processor such as a DSP (Digital Signal Processor) (For example, refer to Jpn. Pat. Appln. KOKAI Pub. No. 2002-77416).

In the above system, the number of calls which a voice recording and playback apparatus can deal with is limited according to the concurrent processing number of calls of the voice processor. Increasing the number of calls which can be concurrently processed requires many expensive voice processors, and causes a problem of increase in the price of the voice recording and playback apparatus.

As IP telephone terminals, there are personal computers and multi-functional telephone terminals having a Web function. However, the voice recording and playback apparatus requests even multifunctional terminals to perform operation by using the same voice guidance as that for conventional telephone terminals. This causes a problem of decreasing user convenience.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic block diagram illustrating a voice recording and playback system to which a voice recording and playback apparatus according to the present invention is applied.

FIG. 2 is a block diagram illustrating a structure of the voice recording and playback apparatus.

FIG. 3 is a block diagram illustrating a structure of an IP telephone terminal.

FIG. 4 is a flowchart illustrating recording processing of a voice from the IP telephone terminal.

FIG. 5 is a flowchart illustrating preparation of a Web page which enables viewing(browsing) of a list of voice data stored in the IP telephone terminal, and management of the voice data such as download and deletion thereof.

FIG. 6 is a flowchart illustrating download and playback of the voice data by the IP telephone terminal.

FIG. 7 is a schematic diagram of an example of the Web page.

FIG. 8 is a schematic diagram illustrating a structure of the downloaded voice data.

### DETAILED DESCRIPTION

Various embodiments according to the invention will be described hereinafter with reference to the accompanying drawings. In general, according to one embodiment of the invention, a voice recording and playback apparatus comprising: a first storage device which stores voice data recorded from an information terminal; a second storage device which receives a request of playing back the voice data stored in the first storage device from the information terminal and, if the information terminal has a Web function, prepares and stores a Web page from which the voice data is downloaded to the information terminal; a transmitting device which transmits URL information to access the Web page stored in the second storage device to the information terminal; and a playback apparatus which plays back the voice data stored in the first storage device, if the information terminal does not have the Web function.

An embodiment of the present invention is described in detail with reference to the drawings.

FIG. 1 is a schematic block diagram illustrating a voice recording and playback system to which a voice recording and playback apparatus according to the present invention is applied. The system is used for, for example, a voice mail service.

The system has a LAN (Local Area Network) 50, for example. The LAN 50 is connected with a plurality of IP telephone terminals (information terminals) 60, and a key telephone unit/exchange 40. The IP telephone terminals 60 are telephone terminals having a call processing function and a media information processing function, and include PDAs (Personal Digital Assistances) and PCs (Personal Computers) and the like.

The LAN 50 is connected with a voice recording and playback apparatus 30. The voice recording and playback apparatus 30 records and stores voice data from at least one of the IP telephone terminals 60 and the key telephone unit/exchange 40 connected to the LAN 50. Further, the voice recording and playback apparatus 30 plays back the stored voice data, and prepares a list of the voice data as a downloadable Web page.

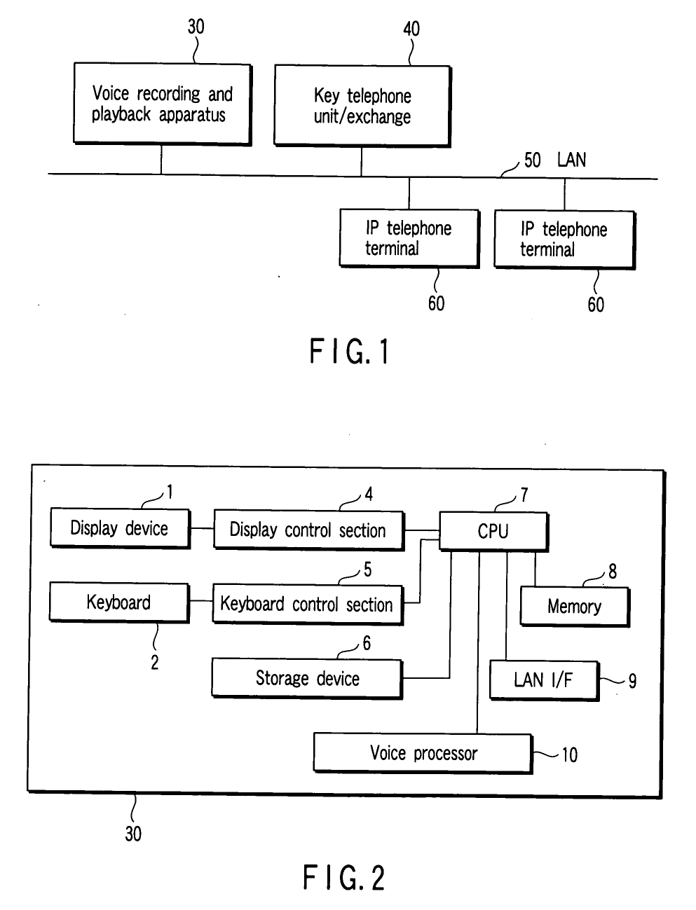

FIG. 2 is a block diagram illustrating a structure of the voice recording and playback apparatus 30.

The voice recording and playback apparatus 30 comprises a voice processor 10 that performs compression and the like of voice data from at least one IP telephone terminal 60 having received a call and the key telephone unit/exchange 40, a CPU 7 that stores and plays back the voice data compressed by the voice processor 10, a storage device 6 that stores voice data, a LAN I/F 9 that is connected to the LAN 50 and transmits and receives signals of incoming and outgoing calls and voice signals, a memory 8 that temporarily stores data, a keyboard 2 and a keyboard control section 5 which serve as an input device, and a display device 1 and a display control section 4 which serve as a display device.

The voice processor 10 converts the voice data stored in the storage device 6 into voice packets in an encoding format determined by negotiation with the IP telephone terminal 60 being a communication party, and transmits the packets to the IP telephone terminal 60 through the LAN I/F 9.

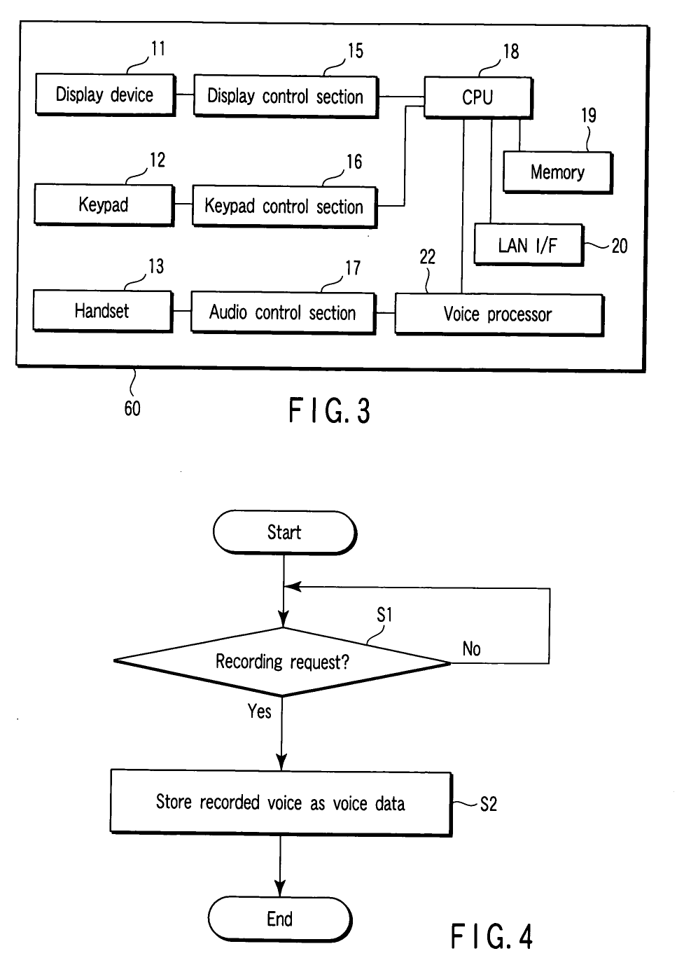

FIG. 3 is a block diagram illustrating a structure of the IP telephone terminal 60.

Each IP telephone terminal 60 comprises a LAN I/F 20 that is connected to the LAN 50 and transmits and receives signals of incoming and outgoing calls and voice signals, a voice processor 22 that performs compression and the like of voice data received by the LAN I/F 20, a CPU 18 that performs control and the like of the IP telephone terminal 60, an audio control section 17 that performs voice processing of the voice data compressed by the voice processor 22, a handset 13 that plays back the voice data processed by the audio control section 17, a memory 19 that stores voice data and the like, a keyboard 12 and a keyboard control section 16 serving as a user interface input device, and a display device 11 and a display control section 15 serving as a display device such as a display.

A voice input from a microphone of the handset 13 of one IP telephone terminal 60 is converted by the audio control section 17 into voice packets in an encoding format determined by negotiation between the voice processor 22 and the voice recording and playback apparatus 30 being a communication party, and is transmitted through the LAN I/F 20.

Next, explained is a voice recording and playback method, to which the voice recording and playback apparatus 30 according to the present invention is applied.

FIG. 4 is a flowchart illustrating recording processing of a voice from one IP telephone terminal 60.

The CPU 7 of the voice recording and playback apparatus 30 determines whether there is a recording request to the IP telephone terminal 60 that has received a call (step S1 of FIG. 4).

If the CPU 7 of the voice recording and playback apparatus 30 determines in step S1 that there is a recording request to the IP telephone terminal 60, the storage device 6 of the voice recording and playback apparatus 30 stores recording contents to the IP telephone terminal 60 as voice data (step S2 of FIG. 4). In this step, the voice data stored in the storage device 6 of the voice recording and playback apparatus 30 is preferably stored in a format that can be played back by the IP telephone terminal 60. Even if it is not a format which can be played back by the IP telephone terminal 60, it can be converted by the voice processor 10 of the voice recording and playback apparatus 30 into a format which can be played back by the IP telephone terminal 60. The stored voice data is managed by using, for example, telephone number information of the IP telephone terminal 60 received from the IP telephone terminal 60.

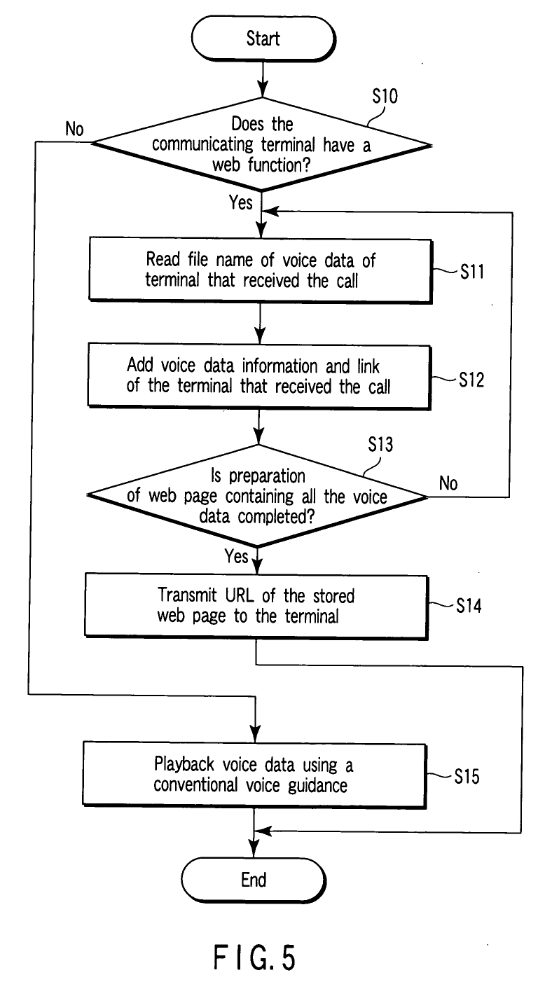

FIG. 5 is a flowchart illustrating preparation of a Web page which enables browsing of a list of voice data stored in the IP telephone terminal 60, and management of the voice data such as download and deletion thereof.

When the CPU 7 of the voice recording and playback apparatus 30 receives a playback request of playing back the recorded voice data from the IP telephone terminal 60, the CPU 7 determines whether the IP telephone terminal 60 being a communication party has a Web function or not (step S10 of FIG. 5).

If the CPU 7 of the voice recording and playback apparatus 30 determines in step S10 that the IP telephone terminal has a Web function, the CPU 7 receives the telephone number information from the IP telephone terminal 60, and reads out the corresponding voice data from the storage device 6 (step S11 of FIG. 5).

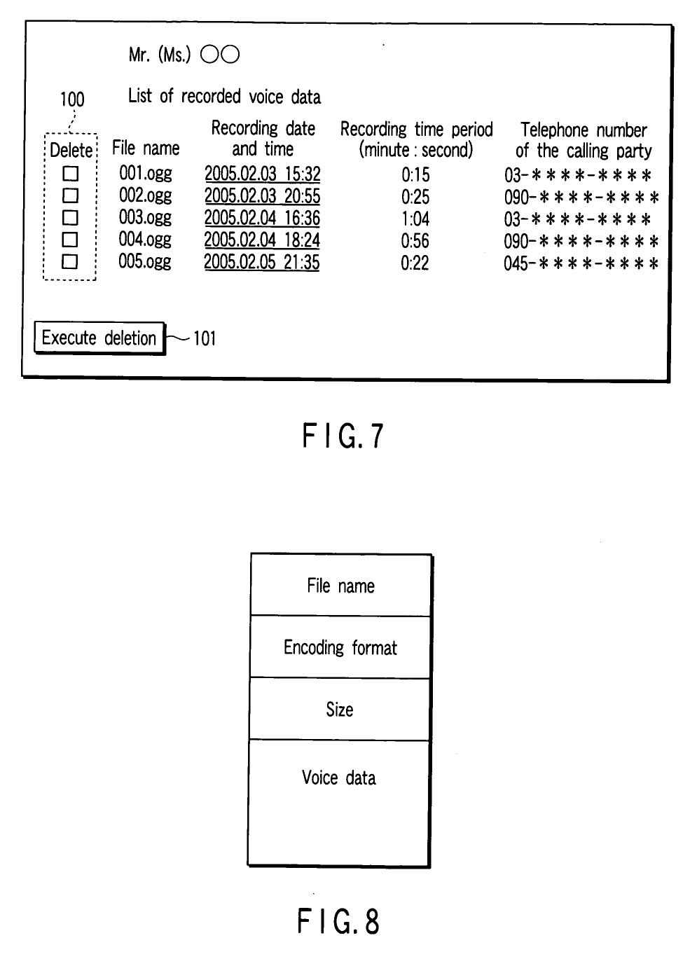

Next, the CPU 7 of the voice recording and playback apparatus 30 prepares a Web page (refer to FIG. 7 explained below) dedicated to the IP telephone terminal 60 that has sent the playback request, by adding the read voice data and link information, by which the read voice data can be downloaded, to the Web page (step S12 of FIG. 5).

The CPU 7 of the voice recording and playback apparatus 30 adds, to the Web page, link information for all the voice data recorded from the corresponding IP telephone terminal 60. If the CPU 7 determines that preparation of the Web page containing a list of all the voice data of the IP telephone terminal 60 is completed (YES of Step S13 of FIG. 5), the CPU 7 stores the prepared Web page in the storage device 6. On the other hand, if the CPU 7 determines in step S13 that the Web page have not yet included all the recorded voice data of the IP telephone terminal 60, the CPU 7 returns to step S11, and add the recorded voice data.

The CPU 7 of the voice recording and playback apparatus 30 transmits URL (Uniform Resource Locator) information being access information of the Web page stored in the storage device 6 to the IP telephone terminal 60 being the terminal that has received the call, by using an IP connection and the like used in call control (step S14 of FIG. 5).

On the other hand, if the CPU 7 of the voice recording and playback apparatus 30 determines that the IP telephone terminal 60 being a communication party does not have a Web function, the CPU 7 performs playback processing of the recorded voice data by using the voice processor 10 of the voice recording and playback apparatus 30 (step S15 of FIG. 5).

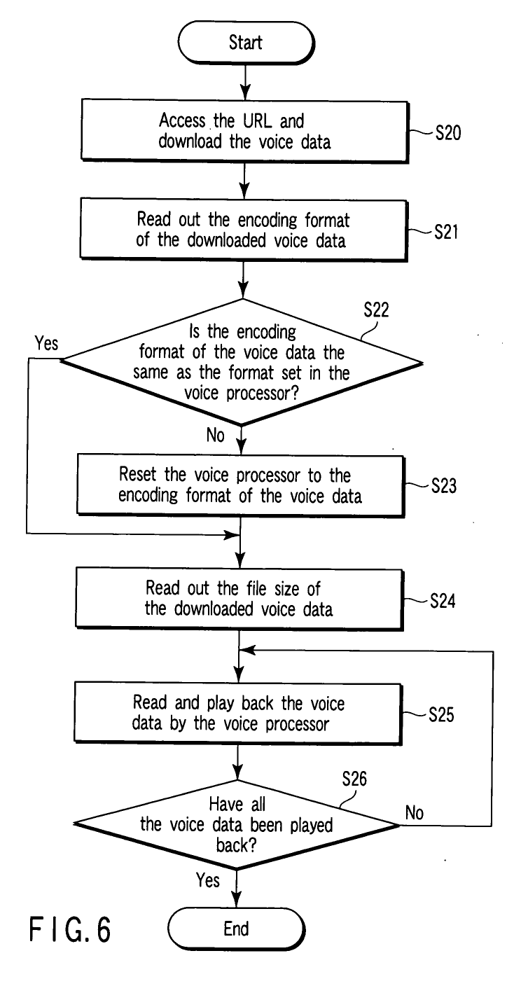

FIG. 6 is a flowchart illustrating download and playback of the voice data by the IP telephone terminal 60.

The IP telephone terminal 60 that has received the URL information accesses the corresponding Web page on the basis of the URL information, by using the Web function of the IP telephone terminal 60.

FIG. 7 is a schematic diagram of an example of the Web page. As shown in FIG. 7, the Web page displays a list of the recorded voice data for the user of the IP telephone terminal 60. If the name of the user is not registered in the storage device 6 of the voice recording and playback apparatus 30, the telephone number information of the IP telephone terminal 60 may be displayed. For example, the Web page dedicated to the user is displayed with the number “090-****-****” displayed.

Further, in the Web page, the voice data is managed with file names assigned to the voice data in the recording order, for example, by the voice recording and playback apparatus 30, and a list of the recording date and time, the recording time period, and the caller's telephone number for each file name is displayed. For example, each recording date and time is underlined and provided with a link to a site for downloading the corresponding voice data.

The Web page may have a function of deleting desired voice data. As shown in FIG. 7, a deletion area 100 is provided with a check box for each file name. A checkbox is marked by, for example, clicking a deletion execution button 101, and thereby the corresponding voice data is deleted from the list.

When one of the above links is selected by a request from the IP telephone terminal 60 that accessed the above Web page, download of the corresponding voice data is started.

FIG. 8 is a schematic diagram illustrating a structure of the downloaded voice data. The voice data comprises, for example, information of a file name of the voice data, information of an encoding format of the voice data, information of a size of the voice data, and the voice data.

When download of the voice data is completed, the IP telephone terminal 60 detects that the downloaded file is voice data, on the basis of an extension like ogg of the file name (for example, “001.ogg” shown in FIG. 7) of the downloaded voice data, and reads the encoding format of the voice data (step S21 of FIG. 6). An original extension such as “ogg” may be used, or “wav” or the like may be used as the extension.

The CPU 18 of the IP telephone terminal 60 compares the encoding format described in the downloaded voice data with the encoding format set in the voice processor 22. If the encoding formats do not agree (NO in step S22 of FIG. 6), the CPU 18 of the IP telephone terminal 60 resets the encoding format of the voice processor 22 to the encoding format described in the voice data (step S23 of FIG. 6). On the other hand, if the encoding formats agree in step S22 (YES of step S22 of FIG. 6), the CPU 18 goes to step S24.

Next, the CPU 18 of the IP telephone terminal 60 reads the size of the downloaded voice data (step S24 of FIG. 6) and, among the downloaded data, inputs voice data of the size which the voice processor 22 can process to the voice process 22. The voice processor 22, to which the voice data has been inputted, converts the input voice data into a predetermined format, and the audio control section 17 plays back the voice data by a speaker or the like of the handset 13 (step S25 of FIG. 6). While the voice data is played back, voice packets received from the LAN I/F 20 are abandoned.

As described above, the downloaded voice data is played back by the handset 13 (and a speaker and the like) of the IP telephone terminal 60 by using the voice processor 22 of the IP telephone terminal 60, and thereby it is possible to simultaneously process a plurality of voices at a low cost, without using many expensive voice processors 10 of the voice recording and playback apparatus 30. Further, managing the recorded messages by using a Web page increases the convenience of the user.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A voice recording and playback apparatus, comprising:
a first storage device which stores voice data recorded from an information terminal;
a second storage device which receives a request of playing back the voice data stored in the first storage device from the information terminal and, if the information terminal has a Web function, prepares and stores a Web page from which the voice data is downloaded to the information terminal;
a transmitting device which transmits URL information to access the Web page stored in the second storage device to the information terminal; and
a playback apparatus which plays back the voice data stored in the first storage device, if the information terminal does not have the Web function.

2. A voice recording and playback apparatus according to claim 1,
wherein the Web page is prepared to enable at least one of browsing and deletion of a list of the voice data.

3. A voice recording and playback apparatus according to claim 1,
wherein, if the information terminal accesses the Web page based on the URL information and requests download of the voice data, the corresponding voice data is read from the second storage device and transmitted to the information terminal.

4. A voice recording and playback apparatus comprising:
a first storage device which stores voice data recorded from an information terminal;
a reading device which receives a request of playing back the voice data stored in the first storage device from the information terminal and, if the information terminal has a Web function, reading the voice data stored in the first storage device;
a second storage device which prepares and stores a Web page by adding link information, from which the voice data is downloaded, to the read voice data;
a transmitting device which transmits URL information of the Web page stored in the second storage device to the information terminal; and
a playback apparatus which plays back the voice data stored in the first storage device, if the information terminal does not have the Web function.

5. A voice recording and playback apparatus according to claim 4,
wherein the Web page is prepared to enable at least one of browsing and deletion of a list of the voice data.

6. A voice recording and playback apparatus according to claim 4,
wherein, if the information terminal accesses the Web page based on the URL information and requests download of the voice data, the corresponding voice data is read from the second storage device and transmitted to the information terminal.

7. A voice recording and playback method used in a system which records and plays back voice in a voice recording and playback apparatus from an information terminal, the method comprising:
first storing of storing voice data recorded from the information terminal in a storage device of the voice recording and playback apparatus;
reading of reading the voice data stored in the storage device, if a request of playing back the voice data stored by the first storing is received from the information terminal;
second storing of preparing a Web page by adding link information, by which the voice data is downloaded, to the read voice data, and storing the Web page in the storage device;
transmitting of transmitting URL information of the Web page stored in the storage device to the information terminal; and
playing back of playing back the voice data stored in the storage device, if the information terminal does not have a Web function.

8. A voice recording and playback method according to claim 7,
wherein the Web page is prepared to enable at least one of browsing and deletion of a list of the voice data.

9. A voice recording and playback method according to claim 7,
wherein, if the information terminal accesses the Web page based on the URL information and requests download of the voice data, the corresponding voice data is read from the storage device and transmitted to the information terminal.
